(19) United States
(12) Patent Application Publication
(10) Pub. No.: US 2026/0073097 A1
(43) Pub. Date: Mar. 12, 2026

(54) SYSTEMS, METHODS, AND FORMULATION FOR MODELLING COMPONENTS WITH REQUIRED ELECTRICAL AND MAGNETIC PARAMETERS

(71) Applicants: Rainer Meinke, Concord, MA (US); Erik Soiman, Shirley, NY (US)

(72) Inventors: Rainer Meinke, Concord, MA (US); Erik Soiman, Shirley, NY (US)

(21) Appl. No.: 19/319,456

(22) Filed: Sep. 4, 2025

Related U.S. Application Data
(60) Provisional application No. 63/691,331, filed on Sep. 6, 2024.

(51) Int. Cl. G06F 30/27; G06F 30/12; G06F 111/10; G06F 113/10; G06F 119/08; G06F 119/18; H01F 5/02

(52) U.S. Cl. CPC G06F 30/27; G06F 30/12; H01F 5/02; G06F 2111/10; G06F 2113/10; G06F 2119/08; G06F 2119/18

(57) ABSTRACT

Embodiments of the present disclosure disclose methods, and systems for modelling components with required electrical and magnetic parameters. The system includes a modelling platform, a processing circuitry and a modelling tool. The processing circuitry is configured to receive user inputs including modelling requirement data related to magnetic and electrical parameters of a component. The processing circuitry computes modelling parameters related to the component based on the modelling requirement data and generates modelling data based on the modelling parameters. The modelling tool is configured to access the modelling data from the processing circuitry and fabricate the component based on the modelling data. The component includes a body including a plurality of conductor grooves configured to receive a set of conductors based on a predetermined winding pattern and a cooling structure configured to receive a cooling medium.

### TECHNICAL FIELD

The present disclosure relates to the field of electrical device fabricating systems and methods, and more particularly relates to a system and method for modelling devices and/or structures using a formulation of materials to achieve required magnetic and electrical parameters.

### BACKGROUND

Electrical components such as coil-based structures are commonly used in various industries, including electronics, automotive, and medical devices. These structures may be made from different materials such as metals (such as copper, aluminium), polymers, or composites, depending on the application. Further, manufacturing techniques for coil-based structures vary based on the design requirements, material, and intended use. The coil-based support structure plays a key role in producing a uniform magnetic field at the magnetic core and minimizing magnetic losses that can affect the output voltage generated by the secondary winding. However, to obtain the required magnetic field and prevent potential failures and hazards, the coil-based structure has to be designed in a specific pattern. Further, designing such specific patterns of the coil-based structures may incur design inaccuracies due to a lack of training or knowledge on the designing techniques.

In recent times, several manufacturing techniques have been implemented to fabricate the coil-based structures. Some examples of the existing manufacturing techniques include machining operations (e.g., CNC machining, milling, turning, etc.), subtractive manufacturing techniques, chemical machining, and the like. The existing manufacturing systems and techniques typically require a larger initial material stock (workpiece), and the excess is machined away. In other words, the existing manufacturing techniques often result in significant material waste, as the material is removed and discarded during the manufacturing process. Further, the existing manufacturing systems possess design complexity due to the limited accessibility of the material by the existing manufacturing systems. Typically, certain complex geometries, like intricate internal structures, may be difficult or impossible to create by implementing the existing manufacturing systems and techniques. The existing manufacturing systems may require specialized tooling and fixtures, which can increase setup time and cost.

Therefore, there is a need for an efficient system and method for modelling devices and/or structures with a specific formulation of materials to achieve the required magnetic and electrical parameters to overcome one or more limitations stated above, in addition to providing other technical advantages.

### SUMMARY

Various embodiments of the present disclosure disclose a system and method for modelling devices and/or structures using a formulation of materials to achieve required magnetic and electrical parameters.

In an embodiment, a system is disclosed. The system includes a modelling platform. The modelling platform is configured to receive user inputs including modelling requirement data related to magnetic and electrical parameters of a component. Further, the system includes processing circuitry operatively coupled to the modelling platform. The processing circuitry is configured to compute modelling parameters related to the component based on the modelling requirement data related to the magnetic and electrical parameters of the component. Further, the processing circuitry generates modelling data based on the modelling parameters. The modelling parameters include geometric configuration, material composition, thermal and cooling parameters, and manufacturing parameters. Furthermore, the system includes a modelling tool. The modelling tool is configured to access the modelling data from the processing circuitry and fabricate the component based on the modelling data. The component includes a body and a cooling structure. The body includes a plurality of conductor grooves configured to receive a set of conductors based on a predetermined winding pattern. The cooling structure is configured to receive a cooling medium therein. The cooling structure is aligned with the set of conductors wound based on the predetermined winding pattern, thereby enabling thermal contact of the set of conductors with the cooling medium.

In another embodiment, a method is disclosed. The method performed by processing circuitry includes receiving user inputs that include modelling requirement data related to magnetic and electrical parameters of a component through a modelling platform. The method includes computing the modelling parameters related to the component based on the modelling requirement data related to the magnetic and electrical parameters of the component. Further, the method includes generating modelling data based on the modelling parameters. The modelling parameters include geometric configuration, material composition, thermal and cooling parameters, and manufacturing parameters. Furthermore, the method includes transmitting the modelling data to a modelling tool to fabricate the component.

In another embodiment, a component is disclosed. The component includes a body including a plurality of conductor grooves configured to receive a set of conductors based on a predetermined winding pattern. Further, the component includes a cooling structure configured to receive a cooling medium therein. The cooling structure is aligned with the set of conductors wound based on the predetermined winding pattern, thereby enabling thermal contact of the set of conductors with the cooling medium.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a system, in accordance with an embodiment of the present disclosure;

FIG. 3 illustrates an example scenario of generating the component based on the modelling requirement data, in accordance with an embodiment of the present disclosure; and

FIG. 4 is a flow diagram illustrating the method of modelling a component with the required electrical and magnetic parameters, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

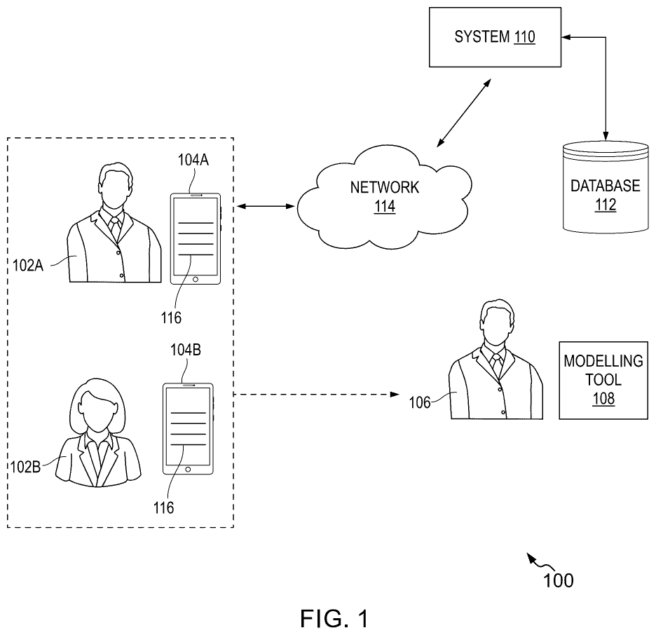

Various example embodiments of the present disclosure are described hereinafter with reference to FIG. 1 to FIG. 4.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise, depending on, for example, generating one or more ensemble model configurations, determining an optimal ensemble model configuration, and the like.

The environment 100 includes a user 102A and a user 102B. The user 102A and the user 102B are associated with a user device 104A and a user device 104B, respectively. The user devices 104A and 104B may include at least a laptop computer, a phablet computer, a handheld personal computer, a virtual reality (VR) device, a netbook, a Web book, a tablet computing device, a smartphone, or other mobile computing devices. In one example, the users 102A-102B may be structural designing professionals who are capable of designing electrical components (e.g., coil-based structures) for the required magnetic and electrical parameters. In another example, the users 102A-102B may be customers who provide inputs related to the required magnetic and electrical parameters for designing the electrical components.

Further, the environment 100 includes a user 106 associated with a modelling tool 108. The user 106 may be a modelling professional or a tool operating personnel. The modelling tool 108 may be configured to create three-dimensional (3D) objects by adding material layer by layer, based on a digital 3D model. In particular, the modelling tool 108 may be configured to execute machine-readable instructions related to a 3D object to create the model of the 3D object. For example, the modelling tool 108 is a 3D printing device. The modelling tool 108 may be referred to as an additive manufacturing device, which will be explained further in detail.

The environment 100 further includes a system 110. The system 110 may be configured to host and manage a modelling platform 116. Further, the modelling platform 116 and one or more components of the modelling platform 116 may be stored in a database 112 associated with the system 110. The database 112 is configured to store user inputs provided by the users 102A-102B. The user inputs may be modelling requirement data. The modelling requirement data may include, but not limited to, material volume, field strength, amperage, material specification (e.g., composition), crystallization temperature, melt temperature, thermal conductivity, modelling area, pattern design, number of layers, resolution ratio and layer height.

Further, the system 110 may communicate with the user devices 104A and 104B via a network 114. The network 114 may include various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 114 may include a secure protocol (e.g., Hypertext Transfer Protocol (HTTP)), and/or any other protocol, or set of protocols. In an example embodiment, the network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof.

The system 110 may be embodied in at least one computing device in communication with the network 114. In an embodiment, the system 110 may be embodied in the user devices 104A-104B. In another embodiment, the system 110 may be implemented as a cloud-based architecture. Further, the modelling platform 116 is a set of computer-executable codes configured to allow the users 102A-102B to create modelling data of a specified structure (i.e., the electrical components). In one embodiment, the modelling platform 116 (hereinafter interchangeably referred to as ‘the platform 116’) may be accessed as a web-based application on the user devices 104A-104B. In another embodiment, the user devices 104A-104B may access an instance of the modelling platform 116 from the system 110 for installation on the user devices 104A-104B using application stores associated with operating systems such as Apple iOS®, Android™ OS, Google Chrome OS, Symbian OS®, Windows Mobile® OS, and the like.

In an embodiment, the user (e.g., the user 102A) may provide user inputs that includes modelling requirement data related to magnetic and electrical parameters of a component or a device in the modelling platform 116. The modelling platform 116 may render user interfaces to allow the user 102A to provide the user inputs that include modelling requirement data, related to the magnetic and electrical parameters of the component. Herein, the component or the device refers to an electrical component. For example, the electrical component may be a bobbin. The bobbin is generally used in various electromagnetic devices such as transformers, inductors, and relays. Typically, the bobbin serves as a spool or core around which wire is wound. In other words, the bobbin is a crucial component that is used to support and insulate wire windings in devices such as transformers, inductors, and relays. The design and material properties of the bobbin are selected based on the specific electrical and mechanical requirements of the intended use. Similarly, other components may be designed using the modelling platform 116, therefore, it should not be considered to limit the scope of the present disclosure.

As explained above, the user 102A accesses the modelling platform 116 to provide the user inputs including modelling requirement data related to the magnetic and electrical parameters of the bobbin (also referred to as ‘the electrical device’). The magnetic and electrical parameters may include volume, field strength, amperage, and so on. The modelling platform 116 creates modelling data based on the user inputs from the user 102A. Thereafter, the modelling data is provided as input to the modelling tool 108. The modelling tool 108 creates the bobbin as per the modelling data.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

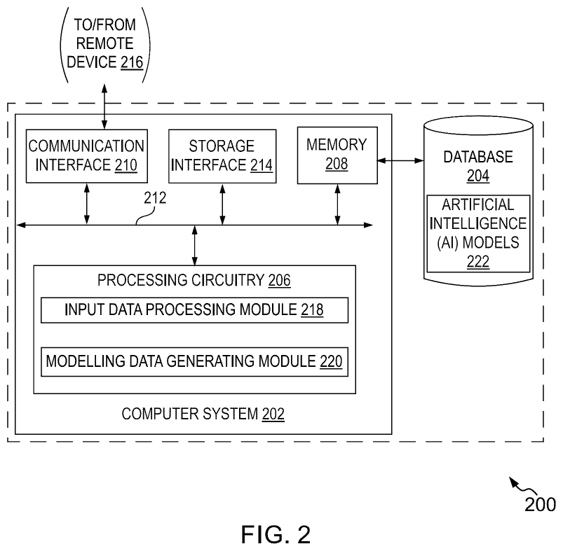

FIG. 2 illustrates a simplified block diagram of a system 200, in accordance with an embodiment of the present disclosure. The system 200 is an example of the system 110 of FIG. 1. In some embodiments, the system 200 is embodied as a cloud-based and/or SaaS-based (software as a service) architecture.

The system 200 includes a computer system 202 and a database 204. The computer system 202 includes processing circuitry 206 for executing instructions, a memory 208, a communication interface 210, and a storage interface 214. One or more components of the computer system 202 communicate with each other via a bus 212. The components of the system 200 provided herein may not be exhaustive and the system 200 may include more or fewer components than those depicted in FIG. 2. Further, two or more components depicted in FIG. 2 may be embodied in one single component, and/or one component may be configured using multiple sub-components to achieve the desired functionalities. The processing circuitry 206 includes a single-core or a multi-core processor without limitation.

In some embodiments, the database 204 is integrated into the computer system 202. In one embodiment, the database 204 is substantially similar to the database 112 in FIG. 1. In one non-limiting example, the database 204 is configured to store the inputs provided by the users 102A-102B related to the modelling of the bobbin. The user inputs may be referred to as modelling requirement data. The modelling requirement data may include, but not limited to, material volume, field strength, amperage, material specification (e.g., composition), crystallization temperature, melt temperature, thermal conductivity, modelling area, pattern design, number of layers, resolution ratio and layer height. Further, the database 112 may be configured to store the instance of the modelling platform 116 and one or more components of the modelling platform 116. The computer system 202 may include one or more hard disk drives as the database 204. The storage interface 214 is any component capable of providing the processing circuitry 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processing circuitry 206 with access to the database 204.

The processing circuitry 206 includes suitable logic, circuitry, and/or interfaces to execute computer-readable instructions. Examples of the processing circuitry 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the system 200, as described herein. In some embodiments, the memory 208 may be realized in the form of a database or cloud storage working in conjunction with the system 200, without deviating from the scope of the present disclosure.

The processing circuitry 206 is operatively coupled to the communication interface 210 such that the processing circuitry 206 is capable of communicating with a remote device 216, such as the user devices 104A-104B, the modelling tool 108, or with any entity connected to the network 114 as shown in FIG. 1.

It is noted that the system 200 as illustrated and hereinafter described, is merely illustrative of an apparatus that could benefit from embodiments of the present disclosure and, therefore, should not be taken to limit the scope of the present disclosure. It is noted that the system 200 may include fewer or more components than those depicted in FIG. 2.

In one embodiment, the processing circuitry 206 includes an input data processing module 218 and a modelling data generating module 220. As such, the one or more components of the processing circuitry 206 as described above are communicably coupled with the modelling platform 116.

The input data processing module 218 includes suitable logic and/or circuitry to receive the user inputs related to the magnetic and electrical parameters required for the bobbin to be designed and processes the user inputs to create the modelling data. The input data processing module 218 is further configured to identify a specific structure of the bobbin based on the user inputs. The database 204 may store predefined structures of the component. In an embodiment, the database 204 may include one or more artificial intelligence (AI) models (see, 222 of FIG. 2) that are trained with a training dataset of the predefined structures, the electrical and magnetic parameters, material formulation, and the like. The trained AI models 222 are deployed for identifying the structure of the component (i.e., the bobbin) based on the user inputs. The AI models 222 are further configured to compute modelling parameters related to the component based on the modelling requirement data related to the magnetic and electrical parameters of the component. In an embodiment, the AI models 222 include surrogate models. The training dataset includes electromagnetic simulation results, thermal simulation results, material property datasets, and geometric configuration data, and the training dataset correlates the modelling requirement data with the modelling data for fabricating the component. Further, it is to be noted that the training dataset correlates the modelling requirement data with the modelling data for fabricating the component. In an embodiment, the AI models 222 may include generative AI models. For example, the generative AI models may include such as a variational autoencoder, a generative adversarial network, or a transformer-based design framework. The generative AI models are trained using the training dataset to learn correlations between geometric parameters, material properties, and performance metrics. In this embodiment, the AI models 222 may perform learning from new fabrication runs, test results, or customer requirements. This ensures that the design suggestions remain optimized as manufacturing technologies and material options evolve.

The modelling data generating module 220 includes suitable logic and/or circuitry to generate the modelling data based on the user inputs. The modelling data generating module 220 may compute modelling parameters based on the user inputs and create the modelling data. The modelling data may be related to a tessellated bobbin. The tessellated structure of the bobbin created by the modelling tool 108 may allow appropriate wiring, power and cooling, and produce the desired magnetic field. Typically, the modelling data is created to assemble a conductor path in 3D space, based on Maxwell's Equations, in order to create the desired field. The modelling parameters include geometric configuration, material composition, thermal and cooling parameters, manufacturing parameters and others.

The modelling data generated by the modelling data generating module 220 may be in a machine-readable format. Some examples of the machine-readable format may include, but not limited to, Stereolithography (STL), Object File (OBJ), and 3D Manufacturing Format (3MF). Thereafter, the modelling data generating module 220 may convert the modelling data into a series of layers. This allows the modelling tool 108 to generate the component (i.e., the bobbin) with high precision. Further, the modelling data generating module 220 may generate instructions corresponding to the modelling data of the bobbin. For example, the instructions may be represented using Geometric code (G-code). Furthermore, the instructions are appended in the modelling data and transmitted to the modelling tool 108 for generating the bobbin with the required magnetic field.

For example, if the user 102A accesses the modelling platform 116 and provides the user inputs, specifying the modelling requirement data that includes the required diameter of the bobbin to be 20 centimetres (cm), and the length of the bobbin is expected to be 20 cm. The modelling platform 116 computes the modelling parameters that include the geometric configuration (e.g., cylinder-like structure with length 20 cm and having the diameter of 20 cm at each end), the material composition (e.g., ceramic), the thermal and cooling parameters of the bobbin and others. Based on the modelling parameters, the modelling platform 116 generates the modelling data in a machine-readable format. The modelling data is transmitted to the modelling tool 108 to fabricate the bobbin with the desired parameters. Further, the modelling data may also specify the precise positions to embed a plurality of conductor grooves (also referred to as conductor grooves) in a body of the bobbin. The conductor grooves are configured to receive conducting material (e.g., conducting wire). Further, the modelling data may also include instructions to fabricate a cooling structure (e.g., thermal cooling channels) on the outer surface or within the bobbin. The cooling structure receives a cooling medium such as liquid coolant. The cooling structure enables direct contact between a set of conductors and the cooling medium. For example, the bobbin may be designed to have a porous region to enable direct contact between the cooling medium and the set of conductors. The modelling tool fabricates the bobbin upon receiving the modelling data from the modelling platform 116. The bobbin, once fabricated and provided with the appropriate set of conductors, power and cooling medium, produces the desired electrical and magnetic parameters.

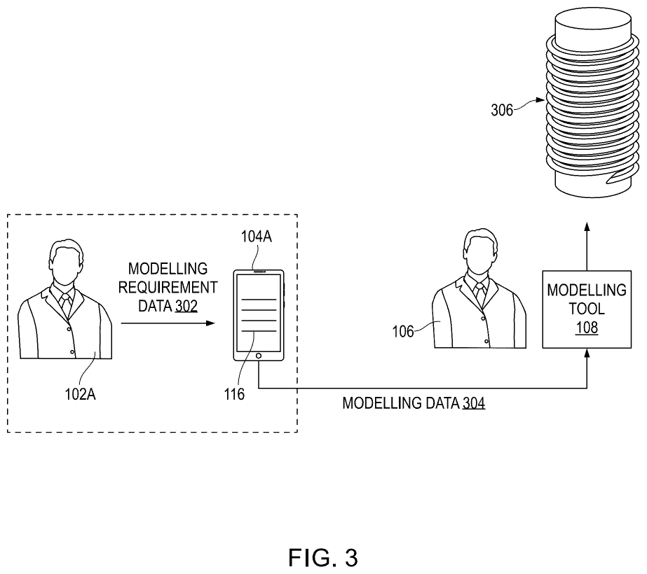

FIG. 3 illustrates an example scenario of generating the component based on the modelling requirement data, in accordance with an embodiment of the present disclosure. As shown, the user 102A provides the user inputs in the modelling platform 116 equipped in the user device 104A. Typically, the user 102A is provided with a user interface (UI) to receive the user inputs upon accessing the modelling platform 116. The user 102A provides the user inputs related to modelling requirement data 302 of a component 306 (e.g., bobbin) to be designed. The modelling requirement data 302 may include the required magnetic and electrical parameters for the bobbin. Thereafter, the processing circuitry 206 (or the modelling platform 116) may derive design parameters, including material volume, field strength, amperage, modelling area, material composition, crystallization temperature, melt temperature, thermal conductivity, pattern design, number of layers, resolution ratio, and layer height based on the modelling requirement data 302. In other words, the modelling platform 116 may compute modelling parameters based on the user inputs. Further, the modelling platform 116 outputs modelling data 304 generated based on the required magnetic and electrical parameters. The modelling data 304 is provided to the modelling tool 108 to create the component 306.

The modelling tool 108 creates three-dimensional (3D) objects (i.e., the component 306) layer by layer based on a digital model (i.e., the modelling data 304). The process of generating the component 306 by creating layer by layer of the component 306 is referred to as an additive manufacturing technique. In other words, the modelling tool 306 is configured to implement the additive manufacturing technique, which enables incrementally adding the material based on the modelling data 304 to form the final object (i.e., the component 306).

The processing circuitry 206 acquires dimensional measurements of the component 306 from the modelling tool 108 and determines dimensional compensation factors by comparing the acquired dimensional measurements to the modelling data. Further, the processing circuitry 206 updates the modelling data with the dimensional compensation factors for subsequent fabrication of the component 306. To ensure the efficiency and reliability of the component 306, the processing circuitry 206 analyses the dimensional measurements of the component 306 after the fabrication. Based on the dimensional measurements, the processing circuitry 206 determines the dimensional compensation factors upon comparing the dimensional measurements and the modelling data. The dimensional compensation factors include adjustments in the modelling data to produce desired electrical and magnetic parameters. The adjustments in the modelling data may include allowable variation in size, form, and location of different structures (e.g., the body of the component, the cooling structure of the component) associated with the component 306. Further, the processing circuitry 206 updates the modelling data with the dimensional compensation factors for subsequent fabrication of the component 306.

The component 306 is hereinafter interchangeably referred to as ‘the bobbin 306’. The bobbin 306 includes a body and may include a cooling structure. The body may be designed to include a plurality of conductor grooves (hereinafter interchangeably referred to as ‘the conductor grooves’) that are precisely positioned in order to accept and fasten a set of conductors based on a predetermined winding pattern. This allows for the formation of high-performance magnetic fields, motors, and transformers/inductors. The conductor grooves that are precisely positioned in order to accept and fasten the set of conductors based on the predetermined winding pattern are appended in the modelling data 304. Several layers of conductor grooves can exist, created by the modelling tool, based on the modelling data.

Further, the modelling data 304 may include data related to a cooling structure (e.g., thermal cooling channels or air cooling channels) of the bobbin 306. The cooling structure may be aligned with the set of conductors wound to the conductor grooves based on the predetermined winding pattern, thus enabling thermal contact of the set of conductors with the cooling medium. Each conductor groove of the plurality of conductor grooves is spatially arranged at a predetermined interval, thereby isolating each conductor of the set of conductors wound on the body based on the predetermined winding pattern. In an embodiment, the body of the component includes one or more fractional parts that are removably coupled to each other in a stacked arrangement to form the body of the component 306. For example, the fractional parts are combined through a precision locking channel to form the body of the component. In another embodiment, the body of the component 306 may be configured as a unified structure.

In one scenario, the bobbin 306 may be designed to include the thermal cooling channels on an outer structure of the bobbin 306. The thermal cooling channels may allow the flow of a liquid coolant therein. The liquid coolant flowing through the cooling structure may be in direct contact with the set of conductors wound on the bobbin 306, thus allowing for higher amperage to be driven through the set of conductors and hence achieve higher magnetic fields than normally possible with standard designs. In an embodiment, the bobbin 306 may be designed to include the air cooling channels on the outer structure of the bobbin 306 or at any other feasible locations of the bobbin 306 that maximize cooling action in the bobbin 306.

It is to be noted that the tessellated structure of the bobbin 306 designed by the modelling tool 108 may include a porous region within the bobbin to facilitate cooling. In particular, the porous region within the bobbin 306 allows contact between the set of conductors and the liquid coolant flowing through the cooling structure. In an embodiment, the porous region of the bobbin 306 may allow the bobbin 306 to be used in superconducting applications where the low temperatures cause damage to bobbins that are made using solid materials. However, creating the bobbin 306 to include the porous region allows for the coolant to flow into the bobbin 306 and reach more surface area of the conductor and allows better heat dissipation in the bobbin 306.

In an embodiment, the bobbin 306 may be designed to include convection based cooling. The convection based cooling is achieved by the bobbin 306 by installing a fan at each end of the bobbin 306 and allowing the air to flow through the porous region of the bobbin 306.

Furthermore, the modelling data 304 may include information related to the formulation of the materials used for modelling the bobbin 306. A durable, electrically insulating, thermally conducting material is used for modelling the bobbin 306. In one example, ceramic materials may be used for modelling the bobbin 306. The ceramic materials may include, but not limited to, alumina, aluminium nitride, silicon carbide, boron nitride and others. In another example, diamond, carbon nanotubes, or any other suitable materials may be used for fabricating the bobbin 306. The fabrication of the bobbin 306 using ceramic materials, diamond, carbon nanotubes may further extend the thermal capabilities of the bobbin 306 while providing neutron radiation protection to the bobbin 306. In some embodiments, the bobbin 306 may be designed using plastic since the liquid coolant flowing through will handle the high heat dissipation, allowing for the plastic to hold its structure. Furthermore, an outer support structure that holds the bobbin 306 within can be created, with valves on each end allowing for the liquid coolant to flow through and directly be in contact with the conductor and the bobbin 306.

In an embodiment, the bobbin 306 may be designed along with the permanent magnet or iron core made from ferromagnetic materials, such as iron-based composites, ferromagnetic material/permanent magnets, to meet high-performance output requirements. The simultaneous modelling allows flux from the ferromagnetic iron core to combine with electromagnetic-based flux from the set of conductors wound based on the winding pattern to produce an extended and high magnetic field, thereby providing superior performance output. Further, various shapes of the bobbin 306 may be created that hold iron filings. In other words, the body of the component 306 may include a containerized structure that is configured to receive conductive materials therein (e.g., iron fillings). Such a configuration of the bobbin 306 generally relates to a ferromagnetic core. Further, connecting and interlocking the iron filling and the bobbin in the correct position enhances the magnetic flux. Furthermore, the iron fillings may be filled in a uniquely shaped component that is manufactured by implementing the additive manufacturing technique. It is to be noted that the uniquely shaped component is designed in such a way that the component (e.g., the component 306) supports a particular and desired flux pattern or direction. Herein, the conductor grooves wrap around a compartment of the uniquely shaped component, which acts as the bobbin (or the component 306). In an embodiment, the compartment of the uniquely shaped component may not include the conductor grooves, but may assemble into the whole bobbin 306 or magnet structure, similar to a puzzle piece that fits in.

Further, the modelling data 304 is designed with high accuracy by incorporating the aforementioned design parameters to create the bobbin 306. Hence, the modelling tool 108 operates precisely and allows repeatable placement of the conductor grooves for the set of conductors (such as the wire) to snap into or other conducting material to fill in the bobbin 306. Such precision, combined with the modelling platform 116 capabilities in positioning of the conductor grooves, may result in uniform and/or high magnetic fields in the bobbin 306.

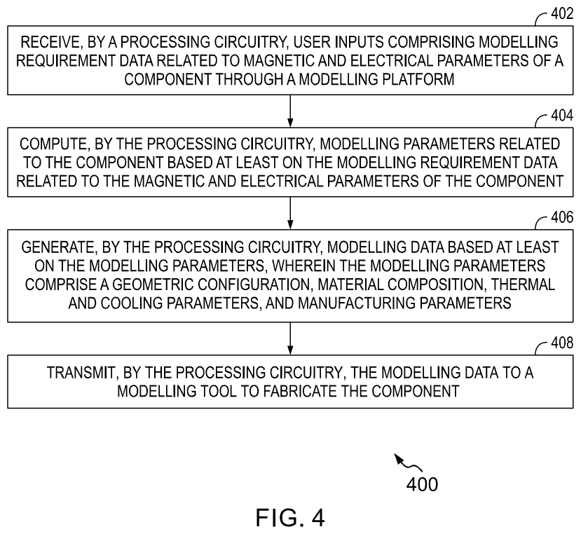

FIG. 4 is a flow diagram illustrating the method 400 of modelling the component 306 with the required electrical and magnetic parameters, in accordance with an embodiment of the present disclosure. The method 400 depicted in the flow diagram is a computer-implemented method that may be executed by, for example, the system 200 explained with reference to FIG. 2. Operations of the flow diagram, and combinations of operations in the flow diagram may be implemented by, for example, hardware, firmware, a processor, circuitry, and/or a different device associated with the execution of software that includes one or more computer instructions. The operations of the method 400 are described herein with the help of the system 200. It is noted that the operations of the method 400 may be described and/or practiced by using a system other than the system 200.

At operation 402, the method 400 includes receiving, by the processing circuitry 206, the user inputs that include modelling requirement data related to magnetic and electrical parameters of the component 306 through the modelling platform 116.

At operation 404, the method 400 includes computing, by the processing circuitry 206, the modelling parameters related to the component 306 based on the modelling requirement data related to the magnetic and electrical parameters of the component 306.

At operation 406, the method 400 includes generating, by the processing circuitry 206, the modelling data based on the modelling parameters. The modelling parameters include the geometric configuration, material composition, thermal and cooling parameters, and manufacturing parameters.

At operation 408, the method 400 includes transmitting, by the processing circuitry 206, the modelling data to the modelling tool 108 to fabricate the component 306. Further, one or more operations related to modelling the component 306 with the required electrical and magnetic parameters are explained with reference to FIGS. 1 to 3, therefore they are not reiterated for the sake of brevity.

Various embodiments of the present disclosure offer multiple advantages and technical effects. Without limiting the scope of the present disclosure, the ability to precisely create multiple layers of the conductor grooves onto the bobbin for wire placement to achieve uniform magnetic fields in the bobbin. Further, modelling multiple layers allows assembling each layer together to form the bobbin. In this scenario, the conductor grooves may be incorporated within each layer, including on the inner layers of the bobbin. The present disclosure further provides the ability to vary the conductor groove cross-section and incorporate the creation of an electrically conductive material (wire) within the conductor groove, which can allow for the creation of higher uniformity magnetic fields, or to optimize electric field and magnetic field uniformity of the winding pattern. Advantageous materials, such as boron nitride, silicon carbide, alumina, carbon nanotubes, diamond, or ultra-pure aluminum and others, can be incorporated into the bobbin for superior performance over conventional materials. Incorporating cooling channels into the bobbin allows for higher cooling capabilities and thus higher amperage and magnetic field. Further, the use of ceramic or similar materials that exhibit electrically insulating and thermally conductive properties is of great benefit. Furthermore, the modelling platform receives the performance requirements or parameters of a magnet or motor as input, and the modelling data for the bobbin improves efficiency. Moreover, the additive manufacturing technique implemented by the modelling tool allows for the creation of complex geometries of the bobbin. The bobbin created is used in applications such as scientific electromagnets, motors, high-performing electrical transformers and inductors.

Various embodiments of the disclosure, as discussed above, may be practiced with steps and/or operations in a different order, and/or with hardware elements in different configurations, than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above.

What is claimed is:

1. A system, comprising:
a modelling platform configured to receive user inputs comprising modelling requirement data related to magnetic and electrical parameters of a component;
processing circuitry operatively coupled to the modelling platform, the processing circuitry configured, at least in part, to:
compute modelling parameters related to the component based at least on the modelling requirement data related to the magnetic and electrical parameters of the component, and
generate modelling data based at least on the modelling parameters, the modelling parameters comprising a geometric configuration, material composition, thermal and cooling parameters, and manufacturing parameters; and
a modelling tool configured to access the modelling data from the processing circuitry and fabricate the component based on the modelling data, the component comprising:
a body comprising a plurality of conductor grooves configured to receive a set of conductors based on a predetermined winding pattern, and
a cooling structure configured to receive a cooling medium therein, wherein the cooling structure is aligned with the set of conductors wound based on the predetermined winding pattern, thereby enabling thermal contact of the set of conductors with the cooling medium.

2. The system as claimed in claim 1, further comprising one or more artificial intelligence (AI) models trained with a training dataset, wherein the one or more artificial intelligence (AI) models are communicably coupled to the processing circuitry and configured to compute the modelling parameters related to the component based at least on the modelling requirement data related to the magnetic and electrical parameters of the component.

3. The system as claimed in claim 2, wherein the one or more artificial intelligence (AI) models comprise surrogate models, and wherein the training dataset comprises electromagnetic simulation results, thermal simulation results, material property datasets, and geometric configuration data.

4. The system as claimed in claim 1, wherein the component comprises a bobbin configured with a tessellated structure defining a porous region within the bobbin to facilitate cooling.

5. The system as claimed in claim 1, wherein each conductor groove of the plurality of conductor grooves is spatially arranged at a predetermined interval, thereby isolating each conductor of the set of conductors wound on the body based on the predetermined winding pattern.

6. The system as claimed in claim 1, wherein the modelling data is generated in a machine-readable format suitable for the modelling tool, the machine-readable format being selected from Stereolithography (STL), 3D Manufacturing Format (3MF), Object File Format (OBJ), and Geometric code (G-code).

7. The system as claimed in claim 1, wherein the modelling tool is configured to implement an additive fabrication technique to fabricate the component based at least on the modelling data.

8. The system as claimed in claim 7, wherein the additive fabrication technique for fabricating the component utilizes at least one of ceramic materials, carbon nanotubes, and diamond.

9. The system as claimed in claim 1, wherein the processing circuitry is further caused, at least in part, to:
acquire dimensional measurements of the component from the modelling tool;
determine dimensional compensation factors by comparing the acquired dimensional measurements to the modelling data; and
update the modelling data with the dimensional compensation factors for subsequent fabrication of the component.

10. The system as claimed in claim 1, wherein the body comprises a containerized structure adapted to receive conductive materials therein and wherein the body comprises one or more fractional parts removably coupled to each other in a stacked arrangement, thereby enabling formation of the body comprising the plurality of conductor grooves for receiving the set of conductors in the predetermined winding pattern.

11. A method, comprising:
receiving, by processing circuitry, user inputs comprising modelling requirement data related to magnetic and electrical parameters of a component through a modelling platform;
computing, by the processing circuitry, modelling parameters related to the component based at least on the modelling requirement data related to the magnetic and electrical parameters of the component;
generating, by the processing circuitry, modelling data based at least on the modelling parameters, wherein the modelling parameters comprise a geometric configuration, material composition, thermal and cooling parameters, and manufacturing parameters; and
transmitting, by the processing circuitry, the modelling data to a modelling tool to fabricate the component.

12. The method as claimed in claim 11, wherein the component comprises a body comprising a plurality of conductor grooves and a cooling structure, wherein the body receives a set of conductors based on a predetermined winding pattern, and the cooling structure receives a cooling medium therein, and wherein the cooling structure is aligned with the set of conductors wound based on the predetermined winding pattern, thereby enabling thermal contact of the set of conductors with the cooling medium.

13. The method as claimed in claim 11, further comprising:
computing, by the processor, the modelling parameters related to the component based at least on the modelling requirement data related to the magnetic and electrical parameters of the component, using one or more artificial intelligence (AI) models trained with a training dataset.

14. The method as claimed in claim 13, wherein the one or more artificial intelligence (AI) models comprise surrogate models, and wherein the training dataset comprises electromagnetic simulation results, thermal simulation results, material property datasets, and geometric configuration data.

15. The method as claimed in claim 11, wherein the modelling data is generated in a machine-readable format suitable for the modelling tool, the machine-readable format being selected from Stereolithography (STL), 3D Manufacturing Format (3MF), Object File Format (OBJ), and Geometric code (G-code).

16. The method as claimed in claim 11, wherein the component is fabricated by implementing an additive fabrication technique based at least on the modelling data, and wherein the additive fabrication technique for fabricating the component utilizes at least one of ceramic materials, carbon nanotubes, and diamond.

17. The method as claimed in claim 11, further comprising:
acquiring, by the processing circuitry, dimensional measurements of the component from the modelling tool;
determining, by the processing circuitry, dimensional compensation factors by comparing the acquired dimensional measurements to the modelling data; and
updating, by the processing circuitry, the modelling data with the dimensional compensation factors for subsequent fabrication of the component.

18. A component, comprising:
a body comprising a plurality of conductor grooves configured to receive a set of conductors based on a predetermined winding pattern; and
a cooling structure configured to receive a cooling medium therein, wherein the cooling structure is aligned with the set of conductors wound based on the predetermined winding pattern, thereby enabling thermal contact of the set of conductors with the cooling medium.

19. The component as claimed in claim 18, wherein the component is fabricated by implementing an additive fabrication technique based at least on modelling data, and wherein the additive fabrication technique for fabricating the component utilizes at least one of ceramic materials, carbon nanotubes, and diamond.

20. The component as claimed in claim 18, wherein the body comprises a containerized structure adapted to receive conductive materials therein.

21. The component as claimed in claim 18, wherein the component comprises a bobbin configured with a tessellated structure defining a porous region within the bobbin to facilitate cooling.

22. The component as claimed in claim 18, wherein each conductor groove of the plurality of conductor grooves is spatially arranged at a predetermined interval, thereby isolating each conductor of the set of conductors wound on the body based on the predetermined winding pattern.

23. The component as claimed in claim 18, wherein the body comprises one or more fractional parts, wherein the one or more fractional parts are removably coupled to each other in a stacked arrangement, thereby enabling formation of the body comprising the plurality of conductor grooves for receiving the set of conductors in the predetermined winding pattern.
